(19) United States
(12) Patent Application Publication
(10) Pub. No.: US 2010/0326475 A1
(43) Pub. Date: Dec. 30, 2010

(54) PIPE CLEANING APPARATUS AND METHOD

(76) Inventor: Young Uk Ku, Gwangju (KR)

Correspondence Address: CHRISTOPHER PAUL MITCHELL, 888 16TH ST., NW, SUITE 800, WASHINGTON, DC, 20006, US

(21) Appl. No.: 12/666,794

(22) PCT Filed: Jun. 24, 2008
(86) PCT No.: PCT/KR08/03610

§ 371 Date: Dec. 24, 2009

(30) Foreign Application Priority Data
Jun. 25, 2007 (KR) 10-2007-0062525

(51) Int. Cl. B08B 9/00

(52) U.S. Cl. 134/22.12; 134/166 C

(57) ABSTRACT

Pipe cleaning apparatus is provided, including a compressed air supply unit, a liquid supply unit, and a control unit. The compressed air supply unit generates compressed air and supplies a target pipe to be cleaned with the generated compressed air. The liquid supply unit pumps a liquid and supplies the target pipe with the pumped liquid. The control unit controls the compressed air supply unit and the liquid supply unit to be alternately supplied with the compressed air and the pumped liquid at a predetermined interval. According to the pipe cleaning apparatus, since the target pipe is alternately supplied with the compressed air and the pumped liquid which have different compression and expansion ratios, the compressed air and the pumped liquid simultaneously undergo compression and expansion to then move forward. In addition, a force of oscillatory movement applied to sludge or scale deposited on the interior surface of the pipe and a movement rate are increased. Therefore, the removal efficiency of the sludge or scale can be improved.

### TECHNICAL FIELD

The present invention relates to a pipe cleaning apparatus and method. More particularly, the present invention relates to a pipe cleaning apparatus using compressed air and a pumped liquid having different physical properties, and a method thereof.

### BACKGROUND ART

In general, a pipe for conveying a fluid may have scale or sludge adhered or deposited on the interior surface of the pipe due to chemical reactions between the fluid and pipe materials and/or chemical reactions between chemical materials contained in the fluid while the fluid is conveyed for an extended period of time.

The scale or sludge adhered or deposited on the interior surface of the pipe diminishes an internal diameter of the pipe, so that a flux of the fluid may be reduced, thereby lowering the efficiency of a piping system and shortening the cycle life of the pipe. In particular, detrimental components, which are harmful to human body, for example, water supply facilities, may be generated.

Accordingly, the scale or sludge adhered or deposited on the interior surface of a pipe has conventionally been removed by a pipe cleaning apparatus of spraying high-pressure air, water or sand into the pipe.

Existing pipe cleaning apparatuses are disclosed in Korean Patent Nos. 10-0217856 and 10-0305181, and Korean Published Patent Application No. 2005-0043041.

In the prior art, a method of intermittently supplying compressed air and an abrasive have to a to-be-cleaned pipe that is fully filled with water has been attempted.

However, according to the method of intermittently supplying compressed air, a force of moving the water filling the pipe forward is based on only the propulsive energy derived from the compressed air. Therefore, in order to isolate sticky materials, e.g., scale, from the pipe, a higher pressure of the compressed air is necessary. In addition, in a case where the pipe is lengthened or the inner diameter of the pipe is large, a required pressure level of compressed air is further increased.

Further, according to the method of intermittently supplying compressed air, an internal pressure of the pipe is instantaneously increased by the supplied compressed air, and the compressed air is dispersed throughout water in a forward direction in a bubble state, resulting in a reduction of the internal pressure of the pipe.

Thus, a force of oscillatory movement applied back and forth to water or air within the pipe is not considerably increased and a cleaning efficiency is not considerably increased.

Further, since a pipe cleaning abrasive supplied with the compressed air is solid matter, the pipe may be damaged during a cleaning operation.

### DISCLOSURE OF INVENTION

### Technical Problem

To solve the above mentioned problems and shortcomings, the present invention provides a pipe cleaning apparatus capable of improving the cleaning efficiency while preventing the pipe from being damaged, and a method thereof.

### Technical Solution

According to an aspect of the present invention, there is provided a pipe cleaning apparatus comprising a compressed air supply unit generating compressed air and supplying a target pipe to be cleaned with the generated compressed air, a liquid supply unit pumping a liquid and supplies the target pipe with the pumped liquid, and a control unit controlling the compressed air supply unit and the liquid supply unit to be alternately supplied with the compressed air and the pumped liquid at a predetermined interval.

The compressed air supply unit comprises a compressor compressing air and generating compressed air, a first conveying conduit through which the compressed air generated by the compressor is conveyed, and a first electronic valve provided along the first conveying conduit and opening/closing a passage in the first conveying conduit.

The liquid supply unit comprises a pump pumping a liquid, a second conveying conduit through which the pumped liquid fed from the pump is conveyed, and a second electronic valve provided along the second conveying conduit and opening/closing a passage in the second conveying conduit.

A confluent conduit of the first and second conveying conduits is connected to the target pipe, so that the compressed air and the pumped liquid conveyed through the first and second conveying conduits are merged as a fluid. The confluent conduit may further comprise oscillation applying means for applying oscillation to the confluent conduit and the fluid conveyed through the confluent conduit.

The pipe cleaning apparatus may further comprise a cleaning solution supply unit provided along the second conveying conduit to supply a cleaning solution into the pumped liquid.

The control unit controls the first and second electronic valves to alternately supply the target pipe with the compressed air and the pumped liquid through the confluent conduit at the predetermined interval.

According to another aspect of the present invention, there is provided a method for cleaning a pipe by injecting a fluid into the pipe, the method comprising alternately supplying a target pipe to be cleaned with compressed air and a pumped liquid for a cleaning operation.

The pipe cleaning method may further comprise applying oscillation to conveying conduits of the compressed air and the pumped liquid.

### ADVANTAGEOUS EFFECTS

According to the pipe cleaning apparatus, since the target pipe is alternately supplied with the compressed air and the pumped liquid which have different compression and expansion ratios, the compressed air and the pumped liquid are subjected to compression and expansion simultaneously while undergoing forward movement. In addition, a force of oscillatory movement applied to sludge or scale deposited on the interior surface of the pipe and a movement rate are increased. Therefore, the removal efficiency of the sludge or scale can be improved.

### BRIEF DESCRIPTION OF THE DRAWINGS

FIG. 1 is block diagram of a pipe cleaning apparatus according to an embodiment of the present invention.

### BEST MODE FOR CARRYING OUT THE INVENTION

An embodiment of the present invention will now be described with reference to the accompanying drawing.

According to an embodiment of the present invention, a target pipe is cleaned by injecting a fluid into the target pipe. In detail, a pipe to be cleaned is first prepared and vacated. Here, compressed air and a pumped liquid having different physical properties are used as the fluid. The compressed air and the pumped liquid are alternately supplied to the target pipe to be cleaned at a predetermined interval.

If the compressed air and the pumped liquid are alternately supplied to the empty pipe, the compressed air, which has a relatively greater compression and expansion ratios than the pumped liquid and has a smaller density than the pumped liquid, strikes in the rear of the pumped liquid that has been conveyed prior to the compressed air, and allows the pumped liquid to move forward. The compressed air strikes the pumped liquid to then move backward due to counteraction, and strikes again the pumped liquid that is subsequently fed to then be compressed for forward movement due to counteraction. These cycles are repeated.

During repeated reciprocation of compressed air, the compressed air moves forward while performing reciprocation on the scale adhered to the interior surface of the pipe back and forth, thereby increasing the cleaning efficiency. In addition, since the compressed air and the pumped liquid are alternately supplied, a forward movement force of the fluid can be increased.

As described above, since the compressed air and the pumped liquid, which are alternately supplied, allow the forward movement and oscillatory movement back and forth due to repeated compression and expansion, foreign substance to be removed can be isolated efficiently from the interior surface of the pipe.

Meanwhile, ultrasonic oscillation may further be applied to a passage through which the compressed air and the pumped liquid are conveyed. In addition, a cleaning chemical for removing sludge and scale in the interior surface of the pipe may be added to the compressed air and the pumped liquid as a cleaning solution.

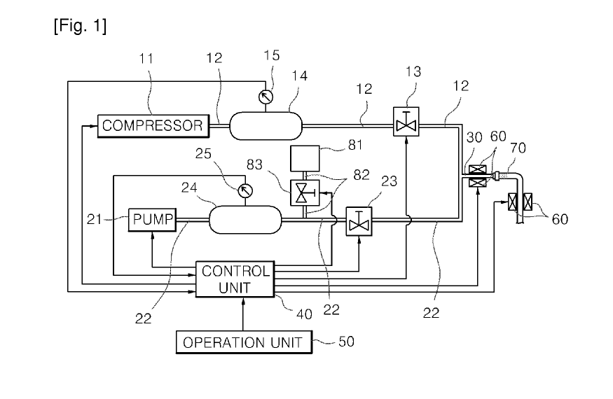

FIG. 1 schematically shows a structure of the pipe cleaning apparatus according to an embodiment of the present invention for implementing the above-described pipe cleaning method.

Referring to FIG. 1, the pipe cleaning apparatus according to the present embodiment includes a compressed air supply unit generating compressed air and supplying a target pipe to be cleaned with the generated compressed air, a liquid supply unit pumping a liquid and supplies the target pipe with the pumped liquid, and a control unit controlling the compressed air supply unit and the liquid supply unit to be alternately supplied with the compressed air and the pumped liquid at a predetermined interval.

The compressed air supply unit includes a compressor 11 compressing air and generating compressed air, a first conveying conduit 12 through which the compressed air generated by the compressor is conveyed, and a first electronic valve 13 provided along the first conveying conduit 12 and opening/closing a passage in the first conveying conduit 12.

Preferably, an air tank 14 storing the compressed air generated by the compressor 11 to be maintained at a constant pressure level may be provided along the first conveying conduit 12.

The air tank 14 includes an air pressure meter 15 for measuring an air pressure value of the air tank 14. The air pressure value measured by the air pressure meter 15 is transmitted to the control unit 40. The control unit 40 having received the air pressure value, and determines a supply time of compressed air or controls ON/OFF of the compressor 11.

The first conveying conduit 12 connects the compressor 11, the air tank 14, and the first electronic valve 13 to a single passage.

The liquid supply unit comprises a pump 21 pumping a liquid, a second conveying conduit 22 through which the pumped liquid fed from the pump 21 is conveyed, and a second electronic valve 23 provided along the second conveying conduit 22 and opening/closing a passage in the second conveying conduit 22.

A liquid tank 24 storing a constant quantity of pumped liquid to be maintained at a constant pressure level is preferably provided along the second conveying conduit 22.

The liquid tank 24 includes a hydraulic pressure meter 25 for measuring the hydraulic pressure value of liquid stored therein. The hydraulic pressure value measured by the hydraulic pressure meter 25 is transmitted to the control unit 40. The control unit 40 having received the hydraulic pressure value controls ON/OFF of the pump 21.

The second conveying conduit 22 connects the pump 21, the liquid tank 24, and the second electronic valve 23 from a liquid source to a single passage.

Meanwhile, the first conveying conduit 12 and the second conveying conduit 22 extend from discharge portions of the first and second electronic valves 13 and 23 by a predetermined length, respectively, and are combined into the single passage.

A confluent conduit 30 of the first and second conveying conduits 12 and 22 is connected to the target pipe, so that the compressed air and the pumped liquid conveyed through the first and second conveying conduits 12 and 22 are combined therein.

The control unit 40 transmits signals for opening/closing a passage to the first and second electronic valves 13 and 23 at the predetermined interval. Thus, the compressed air and the pumped liquid conveyed through the first and second conveying conduits 12 and 22 are alternately discharged through the confluent conduit 30 at the pre-determined interval. The opening/closing time and cycles of the first and second electronic valves 13 and 23 are input to the control unit 40 by means of an operation unit 50. Here, the opening/closing time and cycles of the first and second electronic valves 13 and 23 can be appropriately determined according to the kind of pipe material, the aged state of pipe, or the kind of scale or sludge in the pipe.

The opening/closing time and cycles of the first and second electronic valves 13 and 23 can be adjusted by a timer.

Appropriate air and hydraulic pressure values of the air tank 14 and the liquid tank 24 are input beforehand and stored in the control unit 40. The control unit 40 compares the received air and hydraulic pressure values measured by the air pressure meter 15 and the hydraulic pressure meter 25 with the corresponding values stored in the control unit 40 to control the compressor 11 and the pump 21 to be driven.

Accordingly, the compressed air and the pumped liquid stored in the air tank 14 and the liquid tank 24 are always maintained at a constant pressure level and then discharged with a predetermined pressure level.

The confluent conduit may further include on its outer surface oscillation applying means for applying oscillation to the confluent conduit 30 and the compressed air and the pumped liquid conveyed through the confluent conduit 30.

In addition, a cleaning solution supply unit may further be provided along the second conveying conduit 22 to supply a cleaning solution into the pumped liquid.

In the present embodiment, an ultrasonic wave generator 60 for applying ultrasonic oscillation using an ultrasonic oscillator is illustrated by way of an example of the oscillation applying means. Alternatively, a vibratory motor, a vibrator, etc., capable of applying minute vibration to the compressed air and the pumped liquid discharged through the confluent conduit 30 may also be used as the oscillation applying means.

The ultrasonic wave generator 60 may also be installed in a target pipe 70 to be cleaned in multitude as well as in the confluent conduit 30.

The cleaning solution supply unit includes a cleaning solution storage tank 81 storing a predetermined quantity of cleaning solution, a third conveying conduit 82 connecting the cleaning solution storage tank 81 and the second conveying conduit 22 to allow the cleaning solution stored in the cleaning solution storage tank 81 to be conveyed to the second conveying conduit 22, and a third electronic valve 83 for opening/closing a passage in the third conveying conduit 82.

A strong acid solution (pH4.5˜1.0) or a strong alkali solution (pH11.0˜14.0) can be used as the cleaning solution.

The ultrasonic wave generator 60 and a third electronic valve 83, i.e., a member of the cleaning solution supply unit, can also be controlled by the control unit 40. The ON/OFF time and cycles of the ultrasonic wave generator 60 and the third electronic valve 83 can be input to the control unit 40 beforehand by the operation unit 50. The ON/OFF time and cycles of the ultrasonic wave generator 60 and the third electronic valve 83 can also be controlled by a timer.

Hereinafter, the operation of the aforementioned pipe cleaning apparatus according to the current embodiment of the present invention will be described.

First, the confluent conduit 30 is connected to a target pipe 70 to be cleaned. The fluid is completely evacuated from the target pipe 70 to make the target pipe 70 vacated.

A user operates the operation unit 50 to set desired pressure levels of the compressed air and liquid stored in the air tank 14 and the liquid tank 24, and inputs the ON/OFF time and cycles of the first and second electronic valves 13 and 23 into the control unit 40. Here, the values of the ON/OFF time and cycles of the first and second electronic valves 13 and 23 may be input beforehand and stored in the control unit 40 so as not to separately input the same during a cleaning operation.

The control unit 40 transmits a control signal to the compressor 11 and the pump 21 to allow the compressed air and liquid to be stored in the air tank 14 and the liquid tank 24.

In addition, if the air pressure value and the hydraulic pressure value output from the air pressure meter 15 and the hydraulic pressure meter 25 reach desired levels as set by the user, the control unit 40 controls the first and second electronic valves 13 and 23 to be alternately turned ON/OFF in a predetermined interval. Then, the compressed air and the pumped liquid are fed to the target pipe 70 through the confluent conduit 30.

The control unit 40 controls the compressor 11 and the pump 21 to be driven so as to allow the values of the compressed air and liquid stored in the air tank 14 and the liquid tank 24 to be maintained at the air pressure value and the hydraulic pressure value, separately from controlling the opening/closing operation of the first and second electronic valves 13 and 23.

Meanwhile, by controlling the first and second electronic valves 13 and 23 to be opened/closed, the compressed air and the pumped liquid supplied from the compressor 11 and the pump 21, respectively, can be alternately fed directly to the target pipe 70 without the air tank 14 and the liquid tank 24.

According to the control signal transmitted from the control unit 40, the first and second electronic valves 13 and 23 are alternately turned ON/OFF in a predetermined interval. Accordingly, the compressed air and the pumped liquid are alternately fed to the target pipe 70 through the confluent conduit 30.

The compressed air that is compressed at high pressure is conveyed fast through the confluent conduit 30 and the pipe 70 as the first electronic valve 13 is turned ON/OFF.

The liquid that is pumped by the pump 21 or that is stored in the liquid tank 24 and has a constant level of hydraulic pressure is conveyed fast through the confluent conduit 30 and the pipe 70 as the second electronic valve 23 is turned ON/OFF.

If the target pipe 70 is continuously supplied alternately with the compressed air and the pumped liquid, the compressed air and the pumped liquid are alternately conveyed to the target pipe 70 through the confluent conduit 30.

The compressed air, which has a relatively greater compression and expansion ratios than the pumped liquid and has a smaller density than the pumped liquid, strikes in the rear of the pumped liquid that has been conveyed prior to the compressed air, and moves backward due to counteraction. The pumped liquid that has been conveyed prior to the compressed air is pressurized in the rear thereof by the compressed air and the conveying speed of the pumped liquid is instantaneously increased to then be compressed.

Then, after striking in the rear of the pumped liquid that has been conveyed prior to the compressed air, the compressed air moves backward due to counteraction, and strikes in front of the pumped liquid moving forward from the rear of the pumped liquid to then be compressed.

As described above, the compressed air and the pumped liquid subjected to repeated cycles of compression and expansion apply oscillation, e.g., swaying right and left, to scale or sludge adhered to the interior surface of the pipe.

Accordingly, the scale or sludge adhered to the interior surface of the target pipe is easily isolated from the pipe by an interfering force of moving forward/backward derived from the compressed air and the pumped liquid.

Therefore, if the compressed air and the pumped liquid are alternately fed to the target pipe 70, the scale or sludge adhered to the interior surface of the pipe is easily isolated from the interior surface of the pipe by oscillatory movement simultaneously performed with forward movement of the compressed air and the pumped liquid. Accordingly, the target pipe can be cleaned more efficiently.

Meanwhile, a cleaning solution can be supplied to the inside of the second conveying conduit 12 through which the pumped liquid is conveyed. The supplying of the cleaning solution is performed by ON/OFF operations of the third electronic valve 83. The third electronic valve 83 receives an ON/OFF control signal from the control unit 40 and is turned ON/OFF.

The third electronic valve 83 may employ a check valve to prevent the pumped liquid from flowing backward to the cleaning solution storage tank 81 due to hydraulic pressure of the pumped liquid.

The ultrasonic wave generator 60 applies ultrasonic oscillation to the compressed air and the pumped liquid to be supplied to the target pipe 70 to activate molecular movement of the compressed air and the pumped liquid. Accordingly, materials adhered to the interior surface of the pipe 70 are easily isolated therefrom.

Further, the ultrasonic wave generator 60 may be installed on the target pipe 70 in multitude.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. A pipe cleaning apparatus comprising:
a compressed air supply unit generating compressed air and supplying a target pipe to be cleaned with the generated compressed air;
a liquid supply unit pumping a liquid and supplies the target pipe with the pumped liquid; and
a control unit controlling the compressed air supply unit and the liquid supply unit to be alternately supplied with the compressed air and the pumped liquid at a predetermined interval.

2. The pipe cleaning apparatus of claim 1, wherein the compressed air supply unit comprises a compressor compressing air and generating compressed air, a first conveying conduit through which the compressed air generated by the compressor is conveyed, and a first electronic valve provided along the first conveying conduit and opening/closing a passage in the first conveying conduit;
the liquid supply unit comprises a pump pumping a liquid, a second conveying conduit through which the pumped liquid supplied from the pump is conveyed, and a second electronic valve provided along the second conveying conduit and opening/closing a passage in the second conveying conduit;
a confluent conduit of the first and second conveying conduits is connected to the target pipe, so that the compressed air and the pumped liquid conveyed through the first and second conveying conduits are merged into a fluid; and
the control unit controls the first and second electronic valves to alternately supply the target pipe with the compressed air and the pumped liquid through the confluent conduit at the predetermined interval.

3. The pipe cleaning apparatus of claim 2, wherein the confluent conduit further comprises oscillation applying means for applying oscillation to the confluent conduit and the fluid conveyed through the confluent conduit.

4. The pipe cleaning apparatus of claim 3, further comprising a cleaning solution supply unit provided along the second conveying conduit to supply a cleaning solution into the pumped liquid.

5. A method for cleaning a pipe by injecting a fluid into the pipe, the method comprising:
alternately supplying a target pipe to be cleaned with compressed air and a pumped liquid for a cleaning operation.

6. The method of claim 5, further comprising applying oscillation to conveying conduits of the compressed air and the pumped liquid.
